(19) United States
(12) Patent Application Publication
(10) Pub. No.: US 2014/0108290 A1
(43) Pub. Date: Apr. 17, 2014

(54) MERCHANT INFLUENCE SCORING

(71) Applicants: Payam Zamani, Danville, CA (US); Paul Charles O'Leary, San Francisco, CA (US)

(72) Inventors: Payam Zamani, Danville, CA (US); Paul Charles O'Leary, San Francisco, CA (US)

(21) Appl. No.: 13/652,246

(22) Filed: Oct. 15, 2012

(51) Int. Cl. G06Q 30/02

(52) U.S. Cl. CPC G06Q 30/0282
USPC 705/347

(57) ABSTRACT

A system and a method are disclosed including computer software interface, such as a webpage, which allows a user to enter one or more merchant identification information and displays automatically computed merchant score(s) to the user indicating a level of influence and/or quality of the entered merchant(s) as perceived by its customers or other businesses. The displayed merchant score may be computed based on multiple predefined parameters collected from various data sources including social networks like Facebook, Google+, Tweeter®, Linkedin®, and the like, as well as from other sources such as internet blogs, newsletters, industry web portals and discussion forums, commercial databases, chamber of commerce, other ratings, coupons, published articles, reviews, and the like.

### TECHNICAL FIELD

This application relates generally to merchant and business rating. More specifically, this application relates to scoring merchants as a substitute or supplement for merchant reviews used by customers in evaluating a merchant.

### BRIEF DESCRIPTION OF THE DRAWINGS

The drawings, when considered in connection with the following description, are presented for the purpose of facilitating an understanding of the subject matter sought to be protected.

FIG. 1 shows an embodiment of a network computing environment wherein the disclosure may be practiced;

FIG. 2 shows an embodiment of a computing device that may be used in the network computing environment of FIG. 1;

FIG. 3 shows an example market place for trading commercial leads;

FIG. 4A shows an example computer interface for scoring a merchant;

FIG. 4B shows an example computer interface for scoring multiple merchants at once; and

FIG. 5 shows an example processing environment for scoring one or more merchants.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while following description references particular social network sites like Facebook® and Google+®, it will be appreciated that the disclosure may be used with other types of data sources, such as blogs, various databases, and the like.

Briefly described, a system and a method are disclosed including computer software interface, such as a webpage, which allows a user to enter one or more merchant identification information and displays automatically computed merchant score(s) to the user, indicating, for example, a level of influence and/or quality of the entered merchant(s) as perceived by its customers or other businesses. The displayed merchant score may be computed based on multiple predefined parameters collected from various data sources including social networks like Facebook, Google+, Tweeter®, Linkedin®, and the like, as well as from other sources such as internet blogs, newsletters, industry web portals and discussion forums, commercial databases, chamber of commerce, other ratings, coupons, published articles, reviews, and the like.

With the ubiquity of internet access there is an ever increasing demand for expanded online services and functions, such as online shopping, research, communication, information sharing, and the like. An individual or business customer intending to make a purchase, or research a product or service, is faced with multitudes of choices and the selection of one or two suitable service or product provider among many may be a daunting task. Most consumers do some level of research by reading reviews, articles, advertisements, and other similar information to make a subjective and/or ad-hoc evaluation of a given provider or merchant. Such methods are at best, time consuming and inconclusive and at worst, misleading resulting in wrong selections and decisions. Therefore, a simple rating of merchants based on many factors, normally not available to a consumer or extremely difficult to obtain and time consuming to review, can be highly advantageous to consumers and merchants alike.

### Illustrative Operating Environment

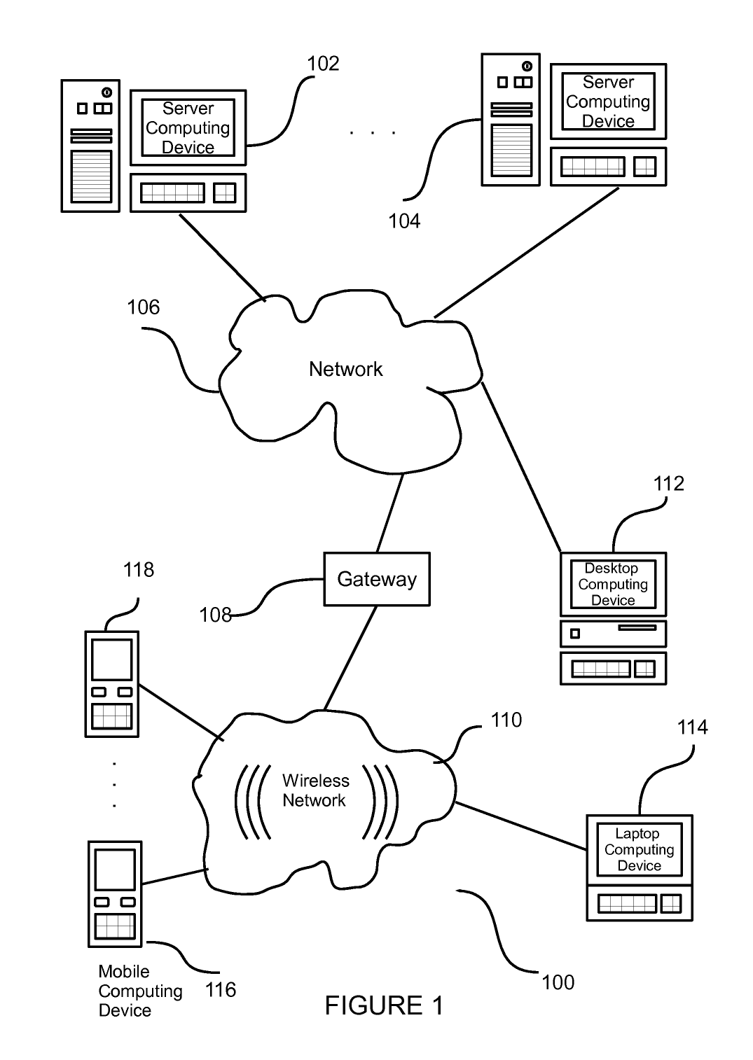

FIG. 1 shows components of an illustrative environment in which the disclosure may be practiced. Not all the shown components may be required to practice the disclosure, and variations in the arrangement and type of the components may be made without departing from the spirit or scope of the disclosure. System 100 may include Local Area Networks (LAN) and Wide Area Networks (WAN) shown collectively as Network 106, wireless network 110, gateway 108 configured to connect remote and/or different types of networks together, client computing devices 112-118, and server computing devices 102-104.

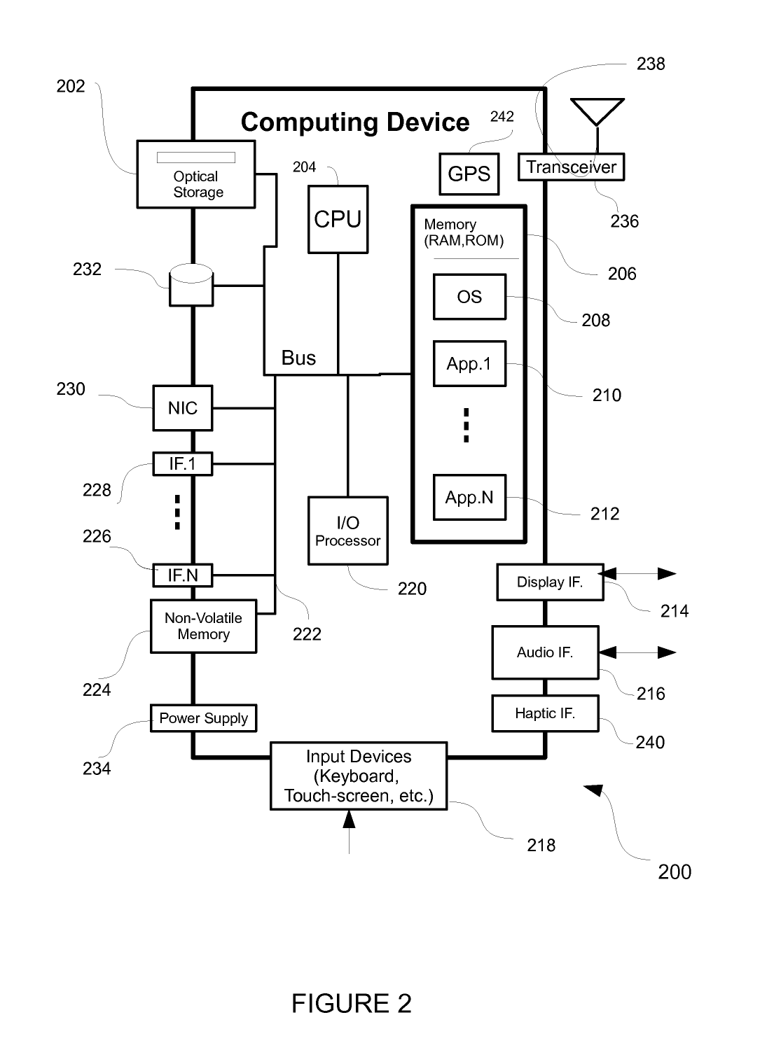

One embodiment of a computing device usable as one of client computing devices 112-118 is described in more detail below with respect to FIG. 2. Briefly, however, client computing devices 112-118 may include virtually any device capable of receiving and sending a message over a network, such as wireless network 110, or the like. Such devices include portable devices such as, cellular telephones, smart phones, digital cameras, display pagers, radio frequency (RF) devices, music players, digital cameras, infrared (IR) devices, Personal Digital Assistants (PDAs), handheld computers, laptop computers, wearable computers, tablet computers, integrated devices combining one or more of the preceding devices, and the like. Client device 112 may include virtually any computing device that typically connects using a wired communications medium such as personal computers, multiprocessor systems, microprocessor-based or programmable consumer electronics, network PCs, or the like. In one embodiment, one or more of client devices 112-118 may also be configured to operate over a wired and/or a wireless network.

Client devices 112-118 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphic may be displayed.

A web-enabled client device may include a browser application that is configured to receive and to send web pages, web-based messages, or the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 12-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, Mobile Identification Number (MIN), an electronic serial number (ESN), mobile device identifier, network address, such as IP (Internet Protocol) address, Media Access Control (MAC) layer identifier, or other identifier. The identifier may be provided in a message, or the like, sent to another computing device.

Client computing devices 112-118 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, to another computing device. However, the present disclosure is not limited to these message protocols, and virtually any other message protocol may be employed.

Client devices 112-118 may further be configured to include a client application that enables the user to log into a user account that may be managed by another computing device. Such user account, for example, may be configured to enable the user to receive emails, send/receive IM messages, SMS messages, access selected web pages, download scripts, applications, or a variety of other content, or perform a variety of other actions over a network. However, managing of messages or otherwise accessing and/or downloading content, may also be performed without logging into the user account. Thus, a user of client devices 112-118 may employ any of a variety of client applications to access content, read web pages, receive/send messages, or the like. In one embodiment, for example, the user may employ a browser or other client application to access a web page hosted by a Web server implemented as server computing device 102. In one embodiment, messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G), generation and any future generation technologies for radio access for cellular systems, WLAN, Wireless Router (WR) mesh, and the like. Access technologies such as 3G, 4G, and future access networks may enable wide area coverage for mobile devices, such as client devices 114-118 with various degrees of mobility. For example, wireless network 110 may enable a radio connection through a radio network access such as Global System for Mobil communication (GSM), General Packet Radio Services (GPRS), Enhanced Data GSM Environment (EDGE), WEDGE, Bluetooth, High Speed Downlink Packet Access (HSDPA), Universal Mobile Telecommunications System (UMTS), Wi-Fi, Zigbee, Wideband Code Division Multiple Access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Also, network 106 may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another.

Communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

### Illustrative Computing Device Configuration

FIG. 2 shows an illustrative computing device 200 that may represent any one of the server and/or client computing devices shown in FIG. 1. A computing device represented by computing device 200 may include less or more than all the components shown in FIG. 2 depending on the functionality needed. For example, a mobile computing device may include the transceiver 236 and antenna 238, while a server computing device 102 of FIG. 1 may not include these components. Those skilled in the art will appreciate that the scope of integration of components of computing device 200 may be different from what is shown. As such, some of the components of computing device 200 shown in FIG. 2 may be integrated together as one unit. For example, NIC 230 and transceiver 236 may be implemented as an integrated unit. Additionally, different functions of a single component may be separated and implemented across several components instead. For example, different functions of I/O processor 220 may be separated into two or more processing units.

With continued reference to FIG. 2, computing device 200 includes optical storage 202, Central Processing Unit (CPU) 204, memory module 206, display interface 214, audio interface 216, input devices 218, Input/Output (I/O) processor 220, bus 222, non-volatile memory 224, various other interfaces 226-228, Network Interface Card (NIC) 320, hard disk 232, power supply 234, transceiver 236, antenna 238, haptic interface 240, and Global Positioning System (GPS) unit 242. Memory module 206 may include software such as Operating System (OS) 208, and a variety of software application programs 210-212. Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central Processing Unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or LINUX™, or a specialized client communication operating system such as Windows Mobile™, or the Symbian® operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like. One common software application is a browser program that is generally used to send/receive information to/from a web server. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed. In one embodiment, using the browser application, a user may view an article or other content on a web page with one or more highlighted portions as target objects.

Display interface 214 may be coupled with a display unit (not shown), such as liquid crystal display (LCD), gas plasma, light emitting diode (LED), or any other type of display unit that may be used with computing device 200. Display units coupled with display interface 214 may also include a touch sensitive screen arranged to receive input from an object such as a stylus or a digit from a human hand. Display interface 214 may further include interface for other visual status indicators, such Light Emitting Diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone (not shown) to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), HDMI (High Definition Multimedia Interface), and the like.

Network Interface Card (NIC) 230 may include circuitry for coupling computing device 200 to one or more networks, and is generally constructed for use with one or more communication protocols and technologies including, but not limited to, Global System for Mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. In another embodiment, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive. Those skilled in the art will appreciate that other technologies and configurations may be used to present a hard drive interface and functionality to computing device 200 without departing from the spirit of the present disclosure.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200, such as a game controller, in a particular way when an event occurs, such as hitting an object with a car in a video game.

Global Positioning System (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

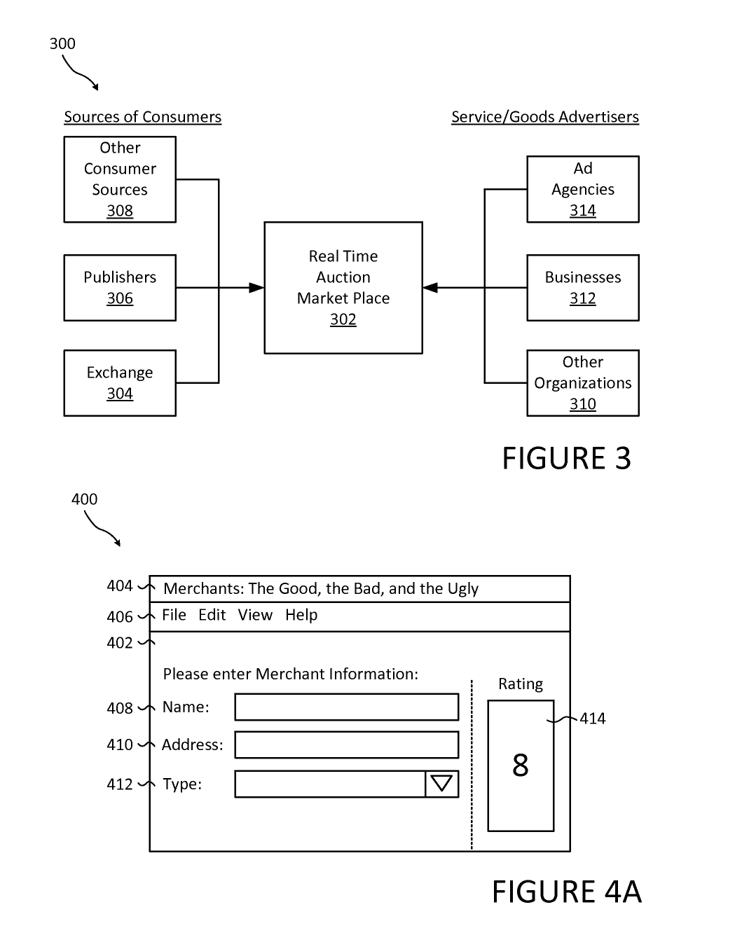

FIG. 3 shows an example market place for trading commercial leads. Market place 300 may include real time auction facility 302, sources of consumers including exchange boards 304, publishers 306, and other consumer sources 308; and service or product advertisers including advertising agencies 314, businesses 312, and other organizations 310.

In various embodiments, auction facility 302 may be an online interface, such as a webpage, to which multiple users may log on to exchange sales leads. Generally, sales leads are potential customers for goods or services. Merchants are interested in obtaining a list of such potential customers to follow up and increase their sales volume. Auction facility 302 may thus be used to sell or buy leads for different industries, goods, or services. Service and/or good providers or advertisers are generally buyers of leads and sources of consumers are generally providers or sellers of consumer leads. For example, industry-specific exchanges such as contractor finding sites or other professional or commercial exchange sites may compile lists of highly relevant leads seriously looking for a specific types of goods or services, which may then be sold to other merchants in the same industry for follow-up. Similarly, publishers who publish and/or distribute advertisements may have access to highly relevant leads.

In this context as well as in other settings, an integrated approach may be implemented by which various merchants may be evaluated and presented to other businesses and/or to individuals. Thus, a business or other consumer may use a one-stop-shopping approach for acquiring decision support information for the review and selection of a merchant as well as for selling and purchasing leads. In various embodiments, these two services, Merchant Scoring (MS) and lead auction, may be connected and offered together. For example, a business interested in buying leads may use the Merchant Scoring (MS) service to evaluate and select the source of leads from which it wants to buy leads.

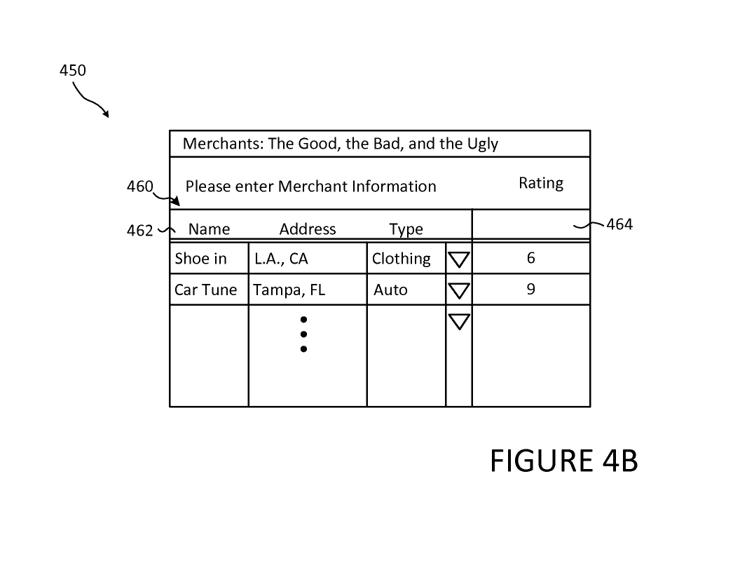

FIG. 4A shows an example computer interface for scoring a merchant. In various embodiments, merchant scoring interface 400 includes a webpage or application window 402 having title bar 404, menu bar 406, merchant information fields such as name field 408, address field 410, and merchant type field 412. Merchant score or Rating 414 is configured to appear as a result of entering merchant information. Such interface may be presented on one or more of the computing devices described above with respect to FIGS. 1 and 2.

In various embodiments, the user interface may be part of a merchant data collection software module configured to collect data about target merchants either via the user interface or automatically from other data sources previously set up for this purpose. For example, the identifying information for a merchant may be recorded in a file or database, the name or identification of which data source is supplied to the merchant data collection software module to read the name of the merchant for further processing and scoring.

In various embodiments, application window 402 may be a dialog box presenting input fields to the user one at a time and displaying the rating after the final input, while in other embodiments, application window 402 may be a webpage configured to obtain user input from various input fields. In still other embodiments, user input may be read by a MS application from a file or database specified by the user.

In various embodiments, input fields may include name field 408, address field 410, and merchant type field 412, each of which may be of various types such as text fields, dropdown lists, pick lists, and other common user input types suitable for data entry. A text field is used to enter text directly by the user, while a pick list presents a list of choices one of which the user selects. In various embodiments, other input fields may be presented (not shown) in the application window. For example, the other input fields may include a locality field for entering the locale the user is interested in, a business subcategory field to further limit the type of business to avoid scoring the wrong business with the same name, a date range field to limit scoring to activities by the target merchant in the given date range, a rating or score type to specify the type of rating the user is interested in, and the like.

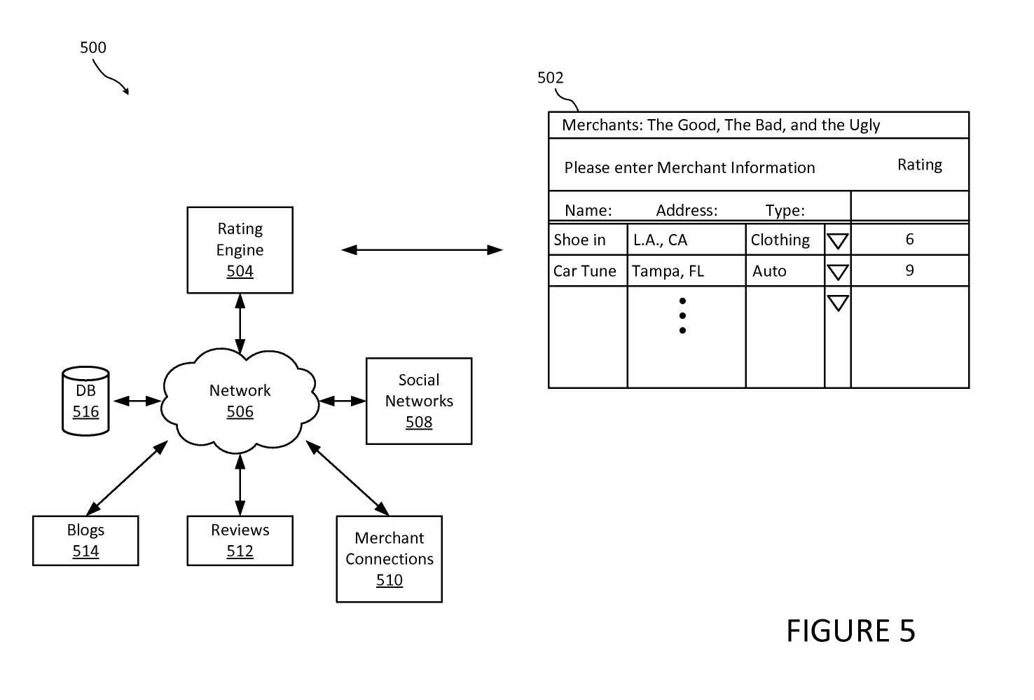

In various embodiments, a rating or score type may be selected by the user to indicate what type or aspects of a score the user is more interested in. For example, a predefined pick list of score types may be presented to the user as one of the input fields. The score types may include merchant influence, merchant stability, merchant quality, merchant loyalty, and the like. Depending on the type of scoring selected by the user, the score may be calculated differently, as further described below with respect to FIG. 5. For example, the score may be calculated based on a different subset of scoring parameters and/or different weights assigned to those scoring parameters.

In operation, in various embodiments, a user, individual or business representative, may log onto or otherwise open the merchant scoring application window to obtain a merchant score for a target merchant. The user enters the identifying information to fully identify the merchant and selects a merchant score type, if available. The user input collected from the application interface is transmitted to a rating or score calculation software module, such as a rating engine, to calculate and provide a score for the target merchant. The score calculation module in turn may obtain the predefined scoring parameters from various data sources for calculation, as further described with respect to FIG. 5.

In various embodiments, instead of collecting the user input from the user interface on the application window, the scoring system may read the target merchant information from a data storage, such as a file system or database, directly and without user involvement, generate a score for each merchant so identified, and either display or store the corresponding scores in a file or database for future use.

The merchant score generally indicates to the user several quantified rating attributes of the merchant, partly depending on the type of score selected. The rating attributes may indicate the quality of the merchant's goods or services, its stability, its social influence, its commercial influence, and the like. The merchant score provides for the user in one or a few numbers or other quantified scores such as letter grades, a reliable indicator of the merchant's rating. This process saves the user from having to read multiple qualitative and quantitative reviews and examine other data about the target merchant and draw his own conclusions about the overall rating of the merchant.

In some embodiments, the calculation process includes at least the selection of scoring parameters and the corresponding weights given to the scoring parameters in generating the merchant score using a weighted average method. In other embodiments, the calculation process may include other techniques to calculate a score. For example, a voting algorithm may be used to calculate the score. Voting algorithms may employ the number or frequency of opinions expressed by various people regarding a target merchant, or consider number of other events, such as mentions, as votes in favor (or against) the target merchant. In still other embodiments, a combination of techniques, such as weighted average of votes may be used to generate the score.

FIG. 4B shows an example computer interface for scoring multiple merchants at once. In various embodiments, merchant scoring interface 450 may be presented by a merchant scoring system, and may include a webpage or application window as described above with respect to FIG. 4A. Information for the multiple target merchants may be entered by the user in tabular form in table 460 having various input columns 462 and rating column 464.

In various embodiments, other input fields may be presented (not shown) in the table in the application window. For example, the other input fields may include a merchant type field such as public or private company, a Doing-Business-As (DBA) field to indicate a business name used in commerce, a locality field for entering the locale the user is interested in, a business subcategory field to further limit the type of business to avoid scoring the wrong business with the same name, a date range field to limit scoring to activities by the target merchant in the given date range, a rating or score type to specify the type of rating the user is interested in, and the like.

In general any attribute of a merchant or company may be used as an input field to further identify and/or influence the score. Each input field may also indicate to the scoring system what aspects of the merchant may be of more importance or significance to the user, thus, allowing adjustment of the weights given to the corresponding parameters in calculating the score. For example, a user may set a date range attribute or input field to the last two years for a target merchant to indicate to the scoring system that more weight be given to the data relevant to this period or to only calculate the score based on data related to this period. Thus, in general, the method of calculation of the merchant score, for example, the weighted average method, may be dependent on the set of merchant attributes selected by the user.

In various embodiments, such input fields may be selected and set globally for all merchants in the input table at once, while in some embodiments, the input fields may be individually settable for each merchant.

In various embodiments, a rating or score type may be selected by the user to indicate what type or aspects of a score the user is more interested in. For example, a predefined pick list of score types may be presented to the user as one of the input fields. The score types may include merchant influence, merchant stability, merchant quality, merchant loyalty, and the like. Depending on the type of scoring selected by the user, the score may be calculated differently, as further described below with respect to FIG. 5. For example, the score may be calculated based on a different subset of scoring parameters and/or different weights assigned to those scoring parameters. Thus, in general, the method of calculation of the merchant score, for example, the weighted average method, may be a function of the type of score selected by the user.

The merchant score may be influenced by several elements including selected merchant attributes (such as name, location, date range, etc.), scoring parameters (such as “likes,” “mentions,” “Tweets,” etc.), and score type (such as influence, quality, stability, etc.) used in the process of determining the merchant score.

Each of the merchant attributes selected by the user limits or defines the merchant in some way. For example, specifying a business type/field or geographic location, helps distinguish one business from another with the same or similar name. Depending on the attributes selected, the merchant calculation process may be changed in different ways. For example, depending on a selected business type, more weight may be given to user reviews than the number of mentions in a social network. In some embodiments, the merchant attributes may be predefined, while in other embodiments, the merchant attributes may be defined by the user. Still in other embodiments, the merchant attributes may be determined dynamically based on results, feedback, or other factors.

In some embodiments, scoring parameters may be selected based on selected merchant attributes, while in other embodiments, scoring parameters are fixed or predetermined. For example, if an electrical contractor for business type/field is entered as a merchant attribute, the number of “likes” scoring parameter may be selected for calculation of the merchant score, while number of Tweets in the Tweeter social network may not be used. In some embodiments, the scoring parameters may be predefined, while in other embodiments, the scoring parameters may be defined by the user. Still in other embodiments, the scoring parameters may be determined dynamically based on results, feedback, or other factors.

The score type is generally distinct from merchant attributes and scoring parameters. Thus, for the same set of merchant attributes or scoring parameters, different types of score may be selected by the user. Conversely, for the same type of score, the user may select different sets of merchant attributes or scoring parameters. Merchant attributes are generally used to limit the target merchant in some way, such as time period, geographic location, a division within a larger merchant (for example, medical equipments division within General Electric Company), or limit/define some other aspect of the merchant. For example, different weighting functions may be used or different subsets of scoring parameters may be used for each one of the selected merchant attributes or score types in calculating the merchant score. Nevertheless, all three elements (merchant attributes, scoring parameters, and score type) may be used by the user to influence the meaning and/or emphasis of the score.

In operation, in various embodiments, a user, individual or business representative, may log onto or otherwise open the merchant scoring application window to obtain merchant scores for multiple target merchants to compare side by side. The user enters the identifying information and attributes important to the user, to fully identify the merchant and direct the emphasis of scoring, respectively, and selects a merchant score type, if a choice is presented. The user input collected from the application interface is transmitted to a rating or score calculation software module, such as a rating engine, to calculate and provide a score for each of the target merchants listed in the table. The score calculation module in turn may obtain the predefined scoring parameters from various data sources for calculation, as further described with respect to FIG. 5.

In various embodiments, the merchant scoring system may sort the multiple target merchants based on their score, while, in other embodiments, no numerical or absolute score is provided and instead the target entered merchants are only ranked relative to each other, such as presenting the best merchant as number one, the next best as number two, and so on.

FIG. 5 shows an example processing environment for scoring one or more merchants. In various embodiments, scoring processing system 500 includes application window 502, rating or scoring engine 504 coupled with computer network 506 in turn coupled with various data sources such as social networks 508, merchant connections 510, user reviews 512, blogs 514, and various databases 516.

In various embodiments, the user enters the desired data about one or more target merchants in the input fields of the application window and indicates, for example, by selecting a “Submit” or “Enter” button on the application window, to the scoring system to start the process of calculating the merchant score. The scoring engine software may employ various mathematical formulae or methods to combine values of various parameters to calculate a score, usually as a weighted average. The general form of weighted average methods may be formulized as follows:

Merchant Score=(Σwᵢpᵢ)/Σwᵢ (1)

Where pᵢ, for i=1, 2, 3, . . . , are various numerical values of parameters, and wᵢ, for i=1, 2, 3, . . . , are corresponding weighting numeric coefficients. In a more general form of equation (1), pᵢ and wᵢ may themselves be functions rather than constants. The weight for a parameter indicates the relative importance or influence of the corresponding parameter in the calculation; the higher the weigh, the more influence it has on the calculated score.

In various embodiments, rating or scoring engine 504 may be implemented as a single software module installed locally as an application on the user's computing device, or remotely on a server to which the user connects and logs on. In other embodiments, the rating engine may be implemented as multiple software modules, each module performing one or more distinct functions such as data collection, communication, database querying and handling, score computation, data storage management, and the like. Those skilled in the art will appreciate that the rating engine may be implemented in other ways without departing from the spirit of the present disclosures. For example, the rating engine may be a web service offered by a third party distinct from the scoring system owner.

Thus, the Merchant Score may be computed as the weighted average of multiple parameters, where the parameters may be chosen by the scoring system, by the users, or by a combination of both. The weighting coefficients may also be chosen by the scoring system, by the users, or by a combination of both, as mentioned before. The parameters used in equation (1) for a particular merchant may be obtained by the scoring system, in particular by the rating engine, from various sources such as social networks, blogs, reviews, and the like. For example, the number of followers of a merchant in one or more social networks, the number of times the merchant is mentioned, the number of purchases made, the number of references to the merchant, the number of reviews of the merchant, the number of positive reviews, the number of negative reviews, and many other parameters may be obtained for calculation of the merchant score. The weighting function provides a coefficient for each of the parameters thus obtained, and the sum of the weighted parameters divided by the sum of the weights yields a merchant score. Those skilled in the art will appreciate that the weighting function may be implemented in other ways and with other formulas without departing from the spirit of the present disclosures, and that the example weighting function presented above is merely a customary weighting function.

Many other parameters may be used for calculating merchant score, such as number of mentions, wall posts, friends, comments, and “likes” in a social network like Facebook; the number of shares, reshares, +1's, and comments in Google+; the number of connections in Linkedin professional network; the number of mentions, Tweets, reTweets, replies, and followers in Twitter; and the like.

Other sources of rating data may be databases listing various types of scores for merchants based on their own criteria and methods; various user ratings from various review sites; various industry or commercial rankings for the merchant, number of coupons acquired or used by customers of the merchant or offered for sale for the merchant, number of hits on the merchant's website; number of links provided to the merchant's website by other entities; density of data such as website hits, messages, or other interactions defined as number of such data events per unit time or per number of stores or products of the merchant; and the like.

The weights applied in calculating the merchant score may be normalized to add up to 1, or may be in any predefined range, such as from 1 to 10 or 1 to 100. The merchant score itself may be a number, a letter, number of starts, a color spectrum or any other similar indicators which indicate relative merit. In various embodiments, the score may be calculated by an equation such as equation (1), and then be mapped to a final score. For example, a score may be normalized and/or mapped to a range of 1-10, range of 1-100, letter grades A-F, and the like.

In various embodiments, calculated merchant scores may be pre-calculated and updated in real-time or periodically, and be stored in a database for presentation to a user upon request. In other various embodiments, the merchant scores may be calculated in real-time when the user enters various information and selects various options on the application window.

In various embodiments, the merchant score may be calculated to rate a merchant characteristic using any suitable technique, whether mathematical, procedural, or both combined, based on the scoring parameters as described above. For example, techniques from set theory may be used to ascertain a rating of a target merchant, such as defining various sets of activities or characteristics associated with the merchant and analyzing the overlap of such sets to draw conclusions regarding its influence, popularity, or quality.

It will be understood that each step in the described processes above can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the disclosure.

Accordingly, combinations of steps of the described processes support combinations of means for performing the specified actions. It will also be understood that each step or combination of steps in the described processes can be implemented by special purpose hardware based systems which perform the specified actions or steps, or combinations of special purpose hardware and computer instructions.

It will be further understood that unless explicitly stated or specified, the steps described in a process are not ordered and may not necessarily be performed or occur in the order described or depicted. For example, a step A in a process described prior to a step B in the same process may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1. A system for scoring merchants, the system comprising:
a merchant data collection software module configured to acquire identifying information selected by a user about a target merchant;
a scoring engine configured to use the acquired identifying information to collect data about predefined scoring parameters related to the target merchant to generate a merchant score for the target merchant; and
wherein a method of calculating the merchant score is dependent upon the identifying information selected by the user, or is dependent upon the scoring parameters, or is dependent upon identifying information and scoring parameters.

2. The system of claim 1, wherein the merchant score is associated with a plurality of score types selected by the user.

3. The system of claim 1, wherein the merchant data collection software module comprises one of a webpage and a computer user interface for data entry by the user.

4. The system of claim 1, wherein the identifying information about a target merchant comprises at least one of a name of the target merchant and a doing-business-as name of the target merchant.

5. The system of claim 1, wherein the merchant data collection software module is configured to acquire identifying information about a plurality of target merchants at the same time for scoring.

6. The system of claim 1, wherein merchant data collection software module acquires the identifying information about the target merchant from one of a file and a database.

7. The system of claim 1, wherein the predefined scoring parameters are obtained from external data sources including one or more of social networks, commercial exchanges, target merchant connections, reviews, and blogs.

8. The system of claim 1, wherein the predefined scoring parameters include at least one or more of:
number of followers of the target merchant in one or more social networks, number of times the target merchant is mentioned in a social network, number of purchases made from the target merchant, number of references to the target merchant, number of reviews of the target merchant, number of positive reviews of the target merchant;
number of wall posts, friends, comments, and “likes” in Facebook social network;
number of shares, reshares, +1's, and comments in Google+ social network;
number of connections in Linkedin professional network; and
number of mentions, tweets, reTweets, replies, and followers in Twitter social network.

9. The system of claim 1, wherein the merchant score is generated based on a weighted average of values of the scoring parameters, wherein coefficients used in the weighted average are functions of the user's selected identifying information.

10. A method of scoring merchants, the method comprising:
acquiring identifying information from a user about a target merchant;
collecting data about predefined scoring parameters for the target merchant; and
generating a merchant score for the target merchant, wherein a method of calculating the merchant score is dependent upon the identifying information selected by the user, the predefined scoring parameters, or upon both.

11. The method of claim 10, wherein acquiring identifying information comprises collecting data entered by a user via a merchant data collection software module.

12. The method of claim 10, wherein collecting data about predefined scoring parameters comprises collecting data from at least one of social networks, commercial exchanges, target merchant connections, reviews, and blogs.

13. The method of claim 10, wherein collecting data about predefined scoring parameters comprises collecting one or more of:
number of followers of the target merchant in one or more social networks, number of times the target merchant is mentioned in a social network, number of purchases made from the target merchant, number of references to the target merchant, number of reviews of the target merchant, number of positive reviews of the target merchant;
number of wall posts, friends, comments, and “likes” in Facebook social network;
number of shares, reshares, +1's, and comments in Google+ social network;
number of connections in Linkedin professional network; and
number of mentions, tweets, reTweets, replies, and followers in Twitter social network.

14. The method of claim 10, wherein generating a merchant score for the target merchant comprises calculating a weighted average of values of the predefined scoring parameters.

15. The method of claim 14, wherein the weighted average is adjusted based on the identifying information about the target merchant.

16. A method of scoring merchants, the method comprising:
using a merchant data collection software module to collect identifying information about a plurality of target merchants;
collecting data about predefined scoring parameters for the target merchants; and
generating a plurality of merchant scores corresponding with the plurality of target merchants using the acquired identifying information and the data about predefined scoring parameters, wherein a method of calculating the plurality of merchant scores is dependent upon the identifying information selected by the user.

17. The method of claim 16, wherein using a merchant data collection software module to collect identifying information about a plurality of target merchants comprises using a website to collect identifying information from the user.

18. The method of claim 16, wherein the different identifying information for one of the plurality of target merchants causes a different merchant score to be generated for the one of the plurality of target merchants.

19. The method of claim 16, wherein collecting data about predefined scoring parameters comprises collecting data from at least one of social networks, commercial exchanges, target merchant connections, reviews, and blogs.

20. The method of claim 16, wherein generating a plurality of merchant scores comprises generating a plurality of merchant scores using a weighted average formula.
